(19) United States
(12) Patent Application Publication
(10) Pub. No.: US 2005/0158485 A1
(43) Pub. Date: Jul. 21, 2005

(54) Recording media

(76) Inventors: Kenichi Kawano, Mitsukaido-shi (JP); Hiroshi Kakihira, Mitsukaido-shi (JP); Akira Kita, Mitsukaido-shi (JP); Hayato Tomihara, Mitsukaido-shi (JP); Koji Fujimoto, Mitsukaido-shi (JP)

Correspondence Address: HARNESS, DICKEY & PIERCE, P.L.C., P.O. BOX 8910, RESTON, VA, 20195, US

(21) Appl. No.: 10/504,071

(22) PCT Filed: Apr. 25, 2003
(86) PCT No.: PCT/JP03/05398

(30) Foreign Application Priority Data
Apr. 25, 2002 (JP) 2002-124596
May 8, 2002 (JP) 2002-133136

(51) Int. Cl. B32B 27/10; B32B 27/32; B32B 27/20; B41M 5/40

(52) U.S. Cl. 428/32.34; 428/500; 428/513

(57) ABSTRACT

A recording medium is composed of a base material and an ink-receiving layer comprising an alumina hydrate and arranged on at least one side of the base material. When heated at 60° C. for 1 hour, the recording medium gives off a lower fatty acid at a concentration in a range of from 0.1 to 1.0 ppm/m₂ L.

### TECHNICAL FIELD

This invention relates to recording media suitable for performing recording with ink, and especially to recording media permitting printing excellent in gloss and ink absorption properties, inhibited in dye migration after printing and also reduced in irritant odor (or offensive odor) of a lower fatty acid from an ink-receiving layer or from the ink-receiving layer shortly after printing when applied to printers or plotters making use of ink-jet recording. In addition, the present invention also relates to recording media which are excellent in gloss and are inhibited in dye migration after printing and also in image fading and discoloration by storage over extended time.

### BACKGROUND ART

Ink-jet recording is a recording technique that performs recording of an image, characters or the like by causing tiny droplets of ink to fly in accordance with one of various operation principles and then allowing them to deposit on a recording medium such as paper. Ink-jet recording features high-speed printing performance, low operating noise, applicability for the recording of a wide variety of characters and patterns, easy multi-color printing, and obviation of development and image fixing. In particular, an image formed by multi-color ink-jet recording can provide a record which is no way inferior to an image printed by multi-color printing making use of a form-plate-dependent printing technique or by a color photographic technique. Ink-jet recording has a still further merit in that, when the number of copies or prints to be made is small, ink-jet recording requires lower printing cost than an ordinary printing technique or photographic technique. Ink-jet recording is, therefore, rapidly finding wide-spread utility as image recorders for various information equipment in recent years.

In such ink-jet recording, improvements have been made in recorders and recording methods to improve recording characteristics, for example, to achieve high-speed recording, high-definition recording and full-color recording. Keeping in step with such improvements, an increasing demand has also arisen for recording media of still higher characteristics. Described specifically, characteristics the demands for which have arisen with respect to recording media to obtain record images at high resolution and high quality comparable with those of silver halide pictures include:
(1) printed dots can have high density and can produce vivid and bright tones,
(2) high contrast can be produced,
(3) ink absorption property is so high that, even when printed dots overlap, ink does not run off or bleed,
(4) spreading or diffusion of ink in horizontal direction does not occur beyond necessity and printed dots have a shape close to a true circle, and
(5) dots are smooth along their peripheries and are well defined.

To meet these requirements, certain proposals have been made to date. For example, JP 52-53012 A discloses ink-jet recording paper of the ordinary plain paper type equipped with ink absorption property increased by applying a surface-processing coating formulation as a thin layer to a base paper stock of low sizing. JP 55-51583 A and JP 64-11877 A each discloses an ink-jet recording medium making use of amorphous silica as a pigment in a coating layer to improve the shape and density of dots or tone reproducibility in which the above-described ink-jet recording paper of the ordinary plain paper type had been considered to be poor. Further, as recording media provided with ink-receiving layers of improved ink absorption properties and permitting formation of images enhanced in gloss and transparency, those each carrying a fine alumina hydrate coated together with a water-soluble binder on a base material have been proposed in recent years as disclosed, for example, in JP 2-276670 A, JP 7-76161 A and JP 11-34484 A.

An alumina hydrate is considered to be an ideal pigment, as it carries a positive charge and has good fixing property for a dye in an ink. To allow a recording medium to exhibit these advantageous features fully, it is necessary to form an ink-receiving layer with a coating formulation in which the alumina hydrate is maintained in a well-dispersed state. To this end, an acid is generally added as a deflocculant in an aqueous sol of the alumina hydrate. For example, JP 4-67985 A and JP 9-24666 A disclose processes for obtaining a well-dispersed, clear sol by adding an organic acid such as acetic acid, formic acid or oxalic acid or an inorganic acid such as nitric acid, hydrochloric acid or sulfuric acid.

To provide images with a gloss as high as that of silver halide pictures, on the other hand, recording media each of which uses as a base material one having high surface smoothness, such as resin-coated paper or a film, and carrying an ink-receiving layer formed on the base material are coming to constitute a mainstream. However, such base materials are low in heat resistance, so that high-temperature drying is not feasible after a coating formulation with the above-described alumina hydrate contained therein is applied. The acid as a deflocculant, therefore, remains in the ink-receiving layers and becomes a cause of production of unpleasant odor. When recording media with images formed thereon are exposed to an environment of high temperature and high humidity, dyes undergo migration, resulting in bleeding of the images. To cope with these problems, a variety of cationic resins have hence been used as color fixatives. When an acid remains in an ink-receiving layer, however, the remaining acid lowers the effects of the cationic resin, thereby failing to bring about satisfactory advantageous effects in some instances. This still remains as an unsolved problem.

With the foregoing current circumstances in view, the present invention has as a first object the provision of a recording medium, which can form images excellent in gloss, has an ink-receiving layer superb in ink absorption property, and is inhibited in irritant odor (or unpleasant odor) of a lower fatty acid produced from the ink-receiving layer or from the ink-receiving layer shortly after printing.

The present invention also has as a second object the provision of a recording medium, which provides high image density, exhibits good tone and ink absorption property, is excellent in gloss, and is inhibited in the migration of dyes after printing and also in image fading and discoloration by storage over extended time.

### DISCLOSURE OF THE INVENTION

The present inventors have proceeded with various investigations to achieve the first object, that is, to obtain a recording medium which permits printing of excellent quality, is inhibited in dye migration and is reduced in unpleasant odor from an ink-receiving layer. As a result, it has been found that the above-mentioned object can be achieved by controlling the concentration of a lower fatty acid, which remains in an ink-receiving layer, to a specific range in a recording medium provided with the ink-receiving layer comprising an alumina hydrate, leading to the completion of the present invention.

The present inventors have also proceeded with various investigations to achieve the second object, that is, to obtain a recording medium which permits printing of excellent quality, is superb in surface gloss, and is inhibited in image fading and discoloration by storage over extended time and also in dye migration. As a result, it has been found that the above-mentioned object can be achieved when in a recording medium having an ink-receiving layer composed of an alumina hydrate, a water-soluble resin and/or a water-dispersible resin, a cationic resin and a boron compound as principal components, the weight proportions of the alumina hydrate, the water-soluble resin and/or the water-dispersible resin, the cationic resin and the boron compound satisfy a particular relationship, leading to the completion of the present invention.

Described specifically, the present invention provides, in a first aspect thereof which achieves the first object, a recording medium composed of a base material and an ink-receiving layer comprising an alumina hydrate and arranged on at least one side of the base material, characterized in that, when heated at 60° C. for 1 hour, the recording medium gives off a lower fatty acid at a concentration in a range of from 0.1 to 1.0 ppm/m²·L.

The present invention also provides, in a second aspect thereof which achieves the first object, a recording medium composed of a base material and an ink-receiving layer formed of an alumina hydrate and arranged on at least one side of the base material, characterized in that, when heated at 60° C. for 1 hour, the recording medium gives off a lower fatty acid at a concentration in a range of from 0.1 to 1.0 ppm/m²·L and, when left over at 23° C. for 10 minutes subsequent to formation of an image on the ink-receiving layer of the recording medium, the recording medium gives off a lower fatty acid at a concentration not higher than 2.5 ppm/m²·L. The recording medium according to the first or second aspect of the present invention may preferably contain a cationic resin in its ink-receiving layer.

The present invention also provides, in a third aspect thereof which achieves the second object, a recording medium sheet composed of a base material and an ink-receiving layer arranged on a surface of the base material, characterized in that the ink-receiving layer comprises:
an alumina hydrate,
at least one binder resin selected from a water-soluble resin and a water-dispersible resin,
a cationic resin, and
a boron compound;
the alumina hydrate, the at least one binder resin, the cationic resin and the boron compound satisfy the following equations (1) and (2):
   A≧20×C Equation (1),
   and
   B≧2×(C+D) Equation (2)
   wherein
A: weight proportion of the alumina hydrate,
B: weight proportion of the at least one binder resin,
C: weight proportion of the cationic resin, and
D: weight proportion of the boron compound; and
the ink-receiving layer has at a surface thereof an arithmetic mean roughness Ra not greater than 0.1 μm when measured by setting the cut-off value and measurement length at 0.25 mm and 1.25 mm as specified in JIS-B-0601.

In the third aspect of the present invention, the cationic resin may preferably be an acrylamide-diallylamine hydrochloride copolymer, the water-soluble resin may preferably be polyvinyl alcohol, and the boron compound may preferably be a boric acid or a borate salt.

Further, the recording medium according to any one of the first to third aspects of the present invention may preferably employ a film or polyolefin-resin-coated paper as the base material.

Owing to the adoption of the constitution of the first or second aspect of the present invention, the recording medium according to the present invention is excellent in printing characteristics, such as image density, color tone and ink absorption property, and also in image gloss and further, is inhibited in dye migration after printing and is reduced in irritant odor (or unpleasant odor) of a lower fatty acid produced from the ink-receiving layer or from the ink-receiving layer shortly after printing.

Owing to the adoption of the constitution of the third aspect of the present invention, the recording medium according to the present invention is excellent in printing characteristics, such as image density, color tone and ink absorption property, and also in gloss and further, is reduced in image fading and discoloration by storage over extended time and also in dye migration

### BEST MODES FOR CARRYING OUT THE INVENTION

The present invention will next be described more specifically based on certain preferred embodiments.

Preferred examples of the base material for use in the present invention can include adequately sized paper, non-sized paper, coated paper, cast-coated paper, and resin-coated paper both sides of which are coated with a resin such as a polyolefin (hereinafter referred to as “resin-coated paper”) transparent films of thermoplastic resins such as polyethylene, polypropylene, polyesters, polylactic acid, polystyrene, polyacetates, polyvinyl chloride, cellulose acetate, polyethylene terephthalate, polymethyl methacrylate and polycarbonates; sheet-like materials (synthetic paper and the like) formed of films opacified by inorganic fillers or fine bubbles; and sheets made of glass or metals. In the present invention, an ink-receiving layer is formed on a base material. From the viewpoint of providing a surface of the ink-receiving layer with an increased gloss, it is preferred to use a film or resin-coated paper which is not water-absorptive and has high smoothness. To improve the adhesion strength between these base materials and the ink-receiving layers, corona discharge treatment or various undercoating treatments can be applied to surfaces of these base materials.

The alumina hydrate for use in the present invention includes one called “aluminum hydroxide”, and can be defined preferably by the following formula (1):
Al₂O₃₋ₙ(OH)₂ₙ.mH₂O (1)
wherein n stands for any one of integers 0, 1, 2 and 3, and m stands for a value of from 0 to 10, preferably from 0 to 5. Because mH₂O represents a removable water phase which may not take part in the formation of a crystal lattice in many instances, m can stands for a value which is not an integer. It is to be noted that m may reach the value of 0 when an alumina hydrate of this sort is subjected to calcination.

Among alumina hydrates represented by the formula (1), an alumina hydrate having the boehmite structure or the pseudo-boehmite structure is more preferred. In general, an alumina hydrate showing the boehmite structure is a layer compound the (020) crystal plane of which forms a huge plane, and shows a particular diffraction peak in its X-ray diffraction pattern. As the boehmite structure, it is possible to take, in addition to complete boehmite structure, a structure containing excess water between layers of (020) planes and called “pseudo-boehmite”. An X-ray diffraction pattern of this pseudo-boehmite shows a broader diffraction peak than complete boehmite. As complete boehmite and pseudo-boehmite are not clearly distinguishable from each other, they will hereinafter be collectively called an alumina hydrate showing the boehmite structure unless otherwise specifically indicated.

No particular limitation is imposed on the process for the production of the alumina hydrate which is included in recording medium according to the present invention. Any process can be adopted including, for example, the Bayer process of the alum pyrolysis process. A particularly preferred process is to hydrolyze a long-chain aluminum alkoxide by adding an acid thereto. The term “long-chain aluminum alkoxide” as used herein means, for example, an alkoxide having 5 or more carbon atoms. Use of an aluminum alkoxide having 12 to 22 carbon atoms is preferred because such a long-chain aluminum alkoxide facilitates elimination of the alcoholic moiety and shape control of the resulting aluminum hydrate as will be described subsequently herein. The above-described process involving hydrolysis of an aluminum alkoxide has a merit in that, compared with production processes of alumina hydrogel or cationic alumina, impurities such as various types of ions can be hardly mixed in. Further, a long-chain aluminum alkoxide has another merit in that, because a long-chain alcohol can be readily eliminated subsequent to hydrolysis, the dealcoholation of the alumina hydrate can be effected completely compared with use of a short-chain alkoxide such as aluminum isopropoxide.

The particulate shape of the alumina hydrate obtained by the above-described process can be controlled to a specific range by adjusting conditions for an aging step in which particles are caused to grow subsequent to a hydrothermal synthesis step. Adequate setting of the aging time permits growth of primary particles of the alumina hydrate, said primary particles being relatively uniform in particle size. The sol so obtained can be used as a dispersion by addition of an acid as a deflocculant. To further improve the dispersibility of the alumina hydrate in water, however, it is preferred to form the sol into a powder by a method such as spray drying and then to add an acid to provide a dispersion.

As the form of the alumina hydrate in the present invention, its average particle size may be preferably in a range of from 150 nm to 250 nm, more preferably in a range of from 160 nm to 230 nm for obtaining an ink-receiving layer of high gloss and high transparency. An alumina hydrate the average particle size of which is smaller than 150 nm leads to a reduction in ink absorption property so that, when printed by a printer of high jetting rate or a printer of high output speed, bleeding or beading may occur. An average particle size greater than 250 nm, on the other hand, results in an ink-receiving layer lowered in transparency and also reduced in gas resistance.

Incidentally, each “average particle size” as referred to herein can be measured by the dynamic light scattering method, and can be determined from an analysis making use of the cumlant method described in “Polymer Structures (2), Scattering Experiments and Form Observations, Chapter 1: Light Scattering” (KYORITSU SHUPPAN CO., LTD.; Compiled by The Society of Polymer Science, Japan) or “J. Chem. Phys., 70 (B), 15 Apl., 3965 (1979)”. The dynamic light scattering method makes use of the phenomenon that, where fine particles having different particle sizes exist as an admixture, there is a distribution in decays of a time correlation function obtained from intensities of scattered light. An analysis of the time correlation function in accordance with the cumlant method makes it possible to determine the mean (Γ) and dispersion (μ) of decay rates. As the decay rates (Γ) is expressed by diffusion coefficients and scattering vectors of particles, a hydrodynamic average particle size can be determined using the Stokes-Einstein equation. Each average particle size defined in the present invention can be readily measured by using, for example, a laser diffraction particle size analyzer, “PARIII” (trade name, manufactured by OTSUKA ELECTRONICS CO., LTD.) or the like.

Further, the alumina hydrate for use in the present invention may preferably have a BET specific surface area of from 40 to 500 m²/g. A BET specific surface area smaller than 40 m²/g means large alumina hydrate particle, results in an ink-receiving layer with impaired transparency, and, when printed, tends to give images which look as if covered with a white haze. A BET specific surface area greater than 500 m²/g, on the other hand, requires a great deal of an acid for the deflocculation of the alumina hydrate. More preferably, the BET specific surface area may be in a range of from 50 to 250 m²/g, with a range of from 50 to 150 m²/g being particularly preferred.

Illustrative of the acid useful in the present invention for the deflocculation of the alumina hydrate are organic acids such as acetic acid, formic acid and oxalic acid; and inorganic acids such as nitric acid, hydrochloric acid and sulfuric acid. From these acids, one or more acids can be chosen and used at will. With such an acid, the alumina hydrate is readily deflocculated into primary particles so that a well-dispersed, uniform dispersion can be obtained. An application of the dispersion, therefore, provides an ink-receiving layer excellent in transparency, smoothness and film properties. As the acid for use in the present invention, a lower fatty acid such as acetic acid is preferred from the viewpoint of relatively easily providing the resulting dispersion with stability such that it can be handled with ease. No particular limitation is imposed on the amount of the acid to be added, and it is only required to add the acid in an amount sufficient to deflocculate and disperse the alumina hydrate. It is preferred to add the acid in a proportion of 0.5 to 60% by weight based on the alumina hydrate. An amount smaller than 0.5 wt. % is not preferred because it results in a coating formulation the viscosity of which increases with time. An amount greater than 60 wt. %, on the other hand, can bring about no greater dispersing effect, and develops problems such as increases in the odor specific to the lower fatty acid and the energy required for drying.

In the present invention, it is preferred to form an ink-receiving layer by using a cationic resin in combination with the alumina hydrate. Examples of the cationic resin can include polyallylamine, polyaminesulfone, polyvinylamine, polyethylene-imine, polyamide-epichlorohydrin resin, polyvinylpyridinium halides, polydimethyldiallylammonium chloride, cation-modified products of polyacrylamide, copolymer of acrylamide with cationic monomer copolymers, copolymers of vinyloxazolidone monomers with other general monomers, and copolymers of vinylimidazole monomers and other general monomers. Preferred can be polyallylamine acetate and hydrochloride and acrylamide-diallylamine hydrochloride copolymers, each of which is excellent in providing a coating formulation with stability and effectively preventing dye migration upon formation of an ink-receiving layer in the present invention. These preferred cationic resins can be used either singly or in combination with plural ones of the above-described other cationic resins.

No particular limitation is imposed on the weight average 25 molecular weight of the cationic resin, although it may range preferably from 1,000 to 200,000, more preferably from 3,000 to 150,000. A weight average molecular weight lower than 1,000 leads to recorded images of insufficient waterproofness, whereas a weight average molecular weight higher than 200,000 results in a coating formulation the viscosity of which is too high to permit easy handling. Further, a cationic resin of high molecular weight tends to lead to a reduction in the efficiency of bonding with dye molecules due to steric hindrance by its molecular structure so that its waterproofness improving effect cannot be sufficiently brought about especially when it is added in a small proportion.

When recording is performed with dye-based inks on an ink-receiving layer containing a cationic resin, the thus-recorded image generally tends to have lowered light fastness although it tends to be provided with improved waterproofness and image density. Further, addition of the cationic resin in a greater proportion leads to a coating formulation the viscosity of which is higher, so that the coating formulation is provided with reduced storability and coating applicability. It is, therefore, preferred to add the cationic resin in as small a proportion as possible. When recording is performed with pigment-based inks, on the other hand, the resulting image is provided with an improved density while permitting prevention of bleeding of the inks of different colors 1. As use of the cationic resin in a large proportion results in an ink-receiving layer the own waterproofness of which is lowered. It is, accordingly, necessary to limit its proportion to the minimum necessity. In the third aspect of the present invention, the cationic resin is added to satisfy A≧20×C (Equation 1) in which A and C have the same meanings as defined above. It is preferred to add the cationic resin in a proportion of from 0.05 to 5% by weight based on the alumina hydrate. Insofar as the proportion of the cationic resin falls within this range, the resulting ink-receiving layer makes it possible to form a recorded image effectively improved in waterproofness and long-term storability under an environment of high temperature and high humidity.

In the present invention, it is preferred to use a water-soluble resin and/or water-dispersible resin, which may also be called “a binder resin” in the present invention, in combination with the alumina hydrate and cationic resin. Illustrative of the water-soluble resin and/or water-dispersible resin for use in the present invention are starch, gelatin and casein, and modified products thereof; cellulose derivatives such as methylcellulose, carboxymethylcellulose and hydroxyethylcellulose; completely or partially saponified polyvinyl alcohols and modified products thereof (including those modified with cations, anions, silanols or the like); urea resins; melamine resins; epoxy resins; epichlorohydrin resins; polyurethane resins; polyethylene-imine resins; polyamide resins; polyvinyl pyrrolidone resins; polyvinyl butyral resins; poly(meth)acrylic acid and copolymers thereof; acrylamide resins; maleic anhydride copolymers; polyester resins; SBR latex; NBR latex; methyl methacrylate-butadiene copolymer latex; acrylic polymer latexes such as acrylate ester copolymers; vinyl polymer latexes such as ethylene-vinyl acetate copolymer; and functional-group-modified polymer latexes formed by bonding cationic groups or anionic groups to a variety of these polymer latexes. Preferred is polyvinyl alcohol obtained by hydrolyzing polyvinyl acetate and having an average polymerization degree of from 300 to 5,000. Its saponification degree may preferably be from 70 to lower than 100%, with 80 to 99.5% being particularly preferred. These water-soluble or water-dispersible resins can be used either singly or in combination.

The water-soluble or water-dispersible resin can be used preferably in a range of from 1/30 to 1/1, more preferably from 1/20 to ⅓ in terms of its mixing weight ratio of the alumina hydrate. Setting of the proportion of the water-soluble resin and/or water-dispersible resin within this range makes it possible to provide the resulting ink-receiving layer with resistance to crazing or separation as dust and also with good ink absorption property.

In the present invention, a hardener may be used to provide a film, which would be formed with the water-soluble or water-dispersible resin, with improved film-forming properties, waterproofness and film. Depending upon the types of reactive groups contained in polymers to be used, various hardeners are generally chosen, respectively. In the case of a polyvinyl alcohol resin, for example, an epoxy hardener or an inorganic hardener such as boric acid or a water-soluble aluminum salt is used. As a hardener for use in the present invention, an oxyacid formed around a boron atom as a center or a salt thereof, such as boric acid or a borate salt, specifically orthophosphoric acid, metaphosphoric acid, hypoboric acid, tetraboric acid or pentaboric acid, or a salt thereof can be used preferably.

The proportion of the boron compound to be used varies depending on the proportion of the water-soluble resin and/water-dispersible resin to be employed as a binder. In general, however, the boron compound may be added in a proportion of from 0.1 to 30% by weight based on the water-soluble resin and/water-dispersible resin. A content of the boron compound lower than 0.1% by weight based on the water-soluble resin and/water-dispersible resin leads to a reduction in film-forming properties so that the resulting ink-receiving layer cannot be provided with sufficient waterproofness. A content higher than 30% by weight, on the other hand, leads to a coating formulation the viscosity of which undergoes significant variations with time so that the coating formulation may be inferior in coating stability in some instances.

The viscosity of the coating formulation in which the water-soluble resin and/or water-dispersible resin is contained is also dependent on the proportion of the cationic resin. As the content of the water-soluble resin and/or water-dispersible resin increases, the viscosity of the resulting coating formulation becomes higher as in the case of the boron compound. It is, therefore, preferred to add the boron compound and the cationic resin to satisfy B≧2×(C+D) (Formula 2) in which B, C and D have the same meanings as defined above. The total amount of the boron compound and cationic resin to be added may be preferably in a range of from 5 to 50% by weight based on the water-soluble and/or water-dispersible resin. Within this range, the resulting coating formulation is less susceptible to gelling and retains coating stability, so that an ink-receiving layer can be applied with high smoothness.

The recording medium according to the present invention can be obtained by mixing a composition, which comprises the alumina hydrate, the cationic resin, the water-soluble resin and/or water-dispersible resin and the boron compound, with a desired amount of an aqueous medium to prepare a coating formulation, applying the coating formulation onto a surface of a base material, and then drying the thus-applied coating formulation to form an ink-receiving layer. No particular limitation is imposed on the aqueous medium in the coating formulation, insofar as it is water or a mixture of water and a water-miscible organic solvent. Examples of the water-miscible organic solvent can include alcohols such as methanol, ethanol and propanol; lower alkyl ethers of polyhydric alcohols, such as ethylene glycol monomethyl ether and ethylene glycol dimethyl ether; ketones such as acetone and methyl ethyl ketone; and ethers such as tetrahydrofuran.

No particular limitation is imposed on the concentration of solids in the coating formulation adapted to form an ink-receiving layer, insofar as the coating formulation has a concentration to give viscosity on such an order that the ink-receiving layer can be formed on the base material. The preferred solid concentration may, however, range from 5 to 50% by weight based on the whole weight of the coating formulation. A solid concentration lower than 5 wt. % leads to a need for increasing the coat weight to form an ink-receiving layer of sufficient thickness. As longer time and greater energy are required for drying, such a low solid concentration may not be economical in some instances. A solid concentration higher than 50 wt. %, on the other hand, results in a coating formulation of high viscosity, and the coatability may be reduced in some instances.

To apply such a coating formulation to a base material, a conventionally-known coating method can be used, such as spin coating, roll coating, blade coating, air knife coating, gate roll coating, bar coating, size pressing, spray coating, gravure coating, curtain coating, rod blade coating, lip coating, or slit die coating. Subsequent to the coating, the surface smoothness of the ink-receiving layer can be improved by using a calender roll or the like as needed.

As a coat weight of the coating formulation to the base material, the preferred range is from 0.5 to 60 g/m², and the more preferred range is from 5 to55 g/m². A coat weight smaller than 0 5 g/m² may result in formation of an ink-receiving layer incapable of absorbing water sufficiently from ink so that the ink may run off or an image may bleed. A coat weight greater than 60 g/m2, on the other hand, leads to occurrence of curling on a recording medium upon drying so that concerning printing performance, advantageous effects may not be brought about to such marked extent as expected.

As a method for using the cationic resin, the cationic resin can be added to have the recording medium, on which the ink-receiving layer containing the alumina hydrate has been formed, impregnated with the cationic resin in addition to adding it directly to the coating formulation as described above. These methods are both applicable in the present invention. In the case of the latter method, the impregnation can be effected by dissolving the cationic resin in a solvent beforehand and then immersing a recording medium in the solution or applying the solution.

The recording medium according to the present invention can be obtained by applying the coating formulation to the base material by one of these coating methods and drying the thus-applied coating formulation in a drier such as a hot air drier, hot drum or far-infrared drier. The base material can be provided on one side thereof with an ink-receiving layer or on both sides thereof with ink-receiving layers, respectively. When ink-receiving layers are applied to both sides, respectively, these ink-receiving layers may have the same composition or different compositions.

In the recording medium of the present invention obtained as described above, it is required to control the concentration of a lower fatty acid, which remains in the ink-receiving layer, within a specific range such that dye migration is inhibited after printing or offensive odor to be given off from the ink-receiving layer is reduced. To control the concentration of the lower fatty acid in the ink-receiving layer, it is desired to preset the temperature high in the drying step or, when the temperature which the base material can withstand is low, to control the drying time. When drying cannot be performed for a sufficient time, for example, due to a limitation imposed on a space available for the installation of a drier although it is desired to conduct drying continuously after the coating, a recording medium which has been dried once may be re-dried by using a constant-temperature drier or a vacuum drier.

In the recording medium according to the present invention, the concentration of the lower fatty acid remaining in the ink-receiving layer of the recording medium is controlled by the above-described method. As the concentration range of the lower fatty acid, a range of from 0.1 to 1.0 ppm/m²·L is preferred in terms of the concentration of the lower fatty acid given off when the recording medium is heated at 60° C. for 1 hour. A lower fatty acid concentration lower than 0.1 ppm/m²·L cannot bring about the advantageous effects of the present invention to significant extent, and conversely, is impractical as the drying step requires higher cost. A lower fatty acid concentration higher than 1.0 ppm/m²·L, on the other hand, may lead to a reduction in the waterproofness of the ink-receiving layer. The term “lower fatty acid concentration” as used herein means the concentration of a lower fatty acid which is released into a predetermined, constant volume (1 L) from the recording medium per unit area (m²).

Further, it is also preferred fox the recording medium that the concentration of a lower fatty acid, which is given off when the recording medium is left over at 23° C. for 10 minutes after formation of an image on the ink-receiving layer, is 2.5 ppm/m²·L or lower, with a range of from 0.1 to 2.0 ppm/m²·L being more preferred. Within this preferred range, it is possible to effectively inhibit dye migration and to effectively reduce offensive odor from the ink-receiving layer upon forming an image.

By forming an ink-receiving layer with the alumina hydrate, the water-soluble resin and/or the water-dispersible resin, the cationic resin and the boron compound as described above, and further, by controlling the arithmetic mean roughness Ra (μm) of the surface of the ink-receiving layer at 0.1 μm or lower as measured by setting the cut-off value and measurement length at 0.25 mm and 1.25 mm, respectively, as specified in JIS-B-0601, a surface of high smoothness can be obtained without additionally using a calender roll or the like after the coating. Use of the recording medium makes it possible to obtain an image excellent in gloss and inhibited in dye migration after the printing and also in image fading and discoloration by storage over extended time.

To the ink-receiving layer of the recording medium according to the present invention, it is also possible to add, to extents not impairing its performance as a recording medium, mordant dyes, mordant pigments, dispersants, thickeners, pH adjusters, lubricants, flow modifiers, surfactants, antistatic agents, defoamers, penetrants, fluorescent whitening agents, ultraviolet absorbers, antioxidants (fading preventives), and the like In particular, use of a thiourea compound as a fading preventive can effectively inhibit image discoloration and fading which are caused by nitrogen oxides, sulfur oxides, ozone and the like in the air.

No particular limitation is imposed on ink to be used upon making a record on the recording medium according to the present invention. It is, however, preferred to use general water-base ink for ink-jet recording, in which a dye or pigment is used as a colorant, a mixture of water and a water-miscible organic solvent is used as a medium, and the dye or pigment is dissolved or dispersed in the medium.

As a method for performing the formation of an image by applying the above-described ink onto the recording medium according to the present invention, ink-jet recording is particularly suited. Any ink-jet recording process can be used insofar as it can apply an ink to a recording medium by effectively causing the ink to fly off from a nozzle. A particularly useful process is an ink-jet recording process such as that disclosed in JP 54-59936 A or the like, in which as a result of exposure to action of thermal energy, an ink undergoes a rapid change in volume and the resulting force forces the ink to jet out.

### EXAMPLES

The present invention will hereinafter be described specifically based on Examples and Comparative Examples, in which each designation of “part” or “parts” or “%” is on a weight basis unless otherwise specifically indicated.

<<First and Second Aspects of the Present Invention>>

Measurements and ranking of various physical properties of each recording medium according to the first or second aspect of the present invention were conducted as will be described hereinafter.

<Measurement 1: Concentration of a Lower Fatty Acid in the Recording Medium>

After four (4) sheets of the recording medium, each having been cut in the A4 size (210×297 mm), were left over at 23° C. and 50% R.H. for 12 hours, they were gently folded in three to prevent the surface of an ink-receiving layer of each individual sheet from coming into close contact with any of the remaining sheets or the inner wall of a sealable container (internal volume: 4 L) equipped with a rubber tube for a gas detector tube, were inserted in the container, and were then sealed there. The container with the sheets sealed inside was heated at 60° C. for 1 hour, and was then allowed to cool down at room temperature for 10 minutes in the air. Using an acetic acid detector tube (“No. 81L”, trade name; manufactured by GASTEC CORPORATION), the concentration of acetic acid inside the container was measured. The value so obtained was subjected to correction in accordance with a temperature (standard: 20° C.) and an atmospheric pressure (standard: 1,013 hPa), and then converted into a corresponding value in ppm/m²·L (the concentration of acetic acid released per unit volume from the recording medium per unit area).

<Measurement 2: Concentration of the Lower Fatty Acid in the Printed Recording Medium>

An A-4 size (210×297 mm) sheet of each recording medium was left over at 23° C. and 50% RH for 12 hours. Using an ink-jet printer (“BJS500”, trade name; manufactured by Canon Inc.), full-page printing of color mixed black was then performed on the ink-receiving layer of the recording medium by the below-described method. Within 10 seconds after completion of the printing, the resultant print was inserted and sealed in a sealable container (internal volume: 4 L), which was equipped with a rubber tube for a gas detector tube, in such a way that the printed side was prevented from coming into contact with the inner wall of the container. Ten (10) minutes later, the concentration of acetic acid inside the container was measured by an acetic acid detector tube (“No. 81L”, trade name; manufactured by GASTEC CORPORATION). The value so obtained was subjected to correction in accordance with a temperature and an atmospheric pressure, and then converted into a corresponding value in the concentration unit (ppm/m²·L ) as in the measurement 1.

<Preparation Method of Printed Image>

Using a graphics preparation tool (Photoshop Version 4.0.1J, product of Adobe Systems), an image of the TIFF format was prepared under the following conditions:
Operation Software: Windows Me (product of Microsoft)
Image size: 210×297 mm
Image mode: RGB color (8 bits/channel)
“Fill” color: Black (R=0, G=0, B=0).

<Printing Method>

Full-page printing was performed using the standard settings as were except that in the menu of printer properties, the following setting changes were made:
Basic settings:
   Media type: Photo Paper Pro
   Color adjustment: Manual
   Print type: Graphics
   Page setup: Printing type: Borderless printing
   Amount of extension: Maximum

<Ranking 1: Migration of Dyes>

Using an ink-jet printer (“BJF900”, trade name; manufactured by Canon Inc.), solid printing (ink dot area: 100%) was performed with single-color inks of yellow (Y), magenta (M), cyan (C) and black (Bk) on each ink-jet recording sheet. Each printed recording medium was exposed for 1 week to an environment of 30° C. and 80% RH. Degrees of migration of the individual dyes were visually ranked. Recording media were ranked “A” where no migration took place with respect to any of the colors, a recording medium was ranked “B” where slight migration took place with respect to any of the colors, and recording media were ranked “C” where significant migration took place with respect to any of the colors.

<Preparation of Alumina Hydrate>

Following the process disclosed in U.S. Pat. No. 4,242,271, aluminum dodexide was prepared. Following the process disclosed in U.S. Pat. No. 4,202,870, the aluminum dodexide was then hydrolyzed to prepare an alumina slurry. Water was added to the alumina slurry until the solid content of an alumina hydrate reached 7.8%. In an autoclave, the slurry was then subjected to aging (aging temperature: 150° C., aging time: 6.5 hours) to obtain a colloidal sol. The colloidal sol was spray-dried into an alumina hydrate powder at an inlet temperature of 87° C. The powder so obtained had a plate-like particle shape, and according to a X-ray diffraction analysis, its crystalline structure showed the pseudo-boehmite structure.

Using a specific surface area and pore distribution measuring instrument (“Micromeritics ASAP2400”, trade name; manufactured by Shimadzu Corporation), the BET specific surface area of the thus-obtained powder was measured. It was found to be 138.9 m²/g.

### Example 1

To deionized water (100 parts), the alumina hydrate (23 parts) and a 6% aqueous solution of acetic acid (11.5 parts, 3% based on the alumina hydrate) were added. The resulting mixture was agitated at 2,000 rpm for 5 minutes in a homomixer (manufactured by Tokushu Kika Kogyo Co., Ltd.) to obtain an alumina hydrate dispersion A [as a result of a measurement of the thus-obtained alumina hydrate dispersion by a laser diffraction particle size analyzer (“PARIII”, trade name; manufactured by OTSUKA ELECTRONICS CO., LTD.), the average particle size of particles of the alumina hydrate was determined to be 173.6 nm]. Mixed in the dispersion A (100 parts) were “SumirezResin 1001” (0.077 part, 0.1% based on the alumina hydrate; trade name, 30% aqueous solution; product of Sumitomo Chemical Co., Ltd.) and a 3% aqueous solution of boric acid (15.3 parts) . To the resulting mixture, a solution (23 parts) of polyvinyl alcohol (5 parts; “PVA-224”, trade name; product of Kuraray Co., Ltd.) in deionized water (45 parts) was added to prepare a coating formulation.

Using resin-coated paper of 234 g/m² in basis weight (product of Oji Paper Co., Ltd.) as a base material, the above-prepared coating formulation was applied to the base material by bar coating to give a dry coat weight of 30 g/m². The thus-coated base material was then dried with hot air at 110° C. for 15 minutes to form an ink-receiving layer. Using the thus-obtained recording medium, the above-described tests for the measurements 1 and 2 and the ranking 1 were conducted. The results are presented in Table 1.

### Example 2

A recording medium was prepared in a similar manner as in Example 1 except that the amount of the cationic resin was changed to 0.767 part (1.0% based on the alumina hydrate), and measurement and ranking tests were conducted. The results are presented in Table 1.

### Example 3

A recording medium was prepared in a similar manner as in Example 2 except that after the coating, drying was conducted at 90° C. for 30 minutes and further at 40° C. for 90 minutes, and measurement and ranking tests were conducted. The results are presented in Table 1.

### Example 4

An alumina hydrate dispersion B (average particle size of alumina hydrate: 172.3 nm) was obtained in a similar manner as in Example 1 except that the amount of the 6% aqueous solution of acetic acid was changed to 26.8 parts (7.0% based on the alumina hydrate). A recording medium was prepared in a similar manner as in Example 1 except that the amount of the cationic resin to be mixed with in the dispersion B was changed to 2.3 parts (3.0% based on the alumina hydrate) and the drying was conducted at 110° C. for 120 minutes, and measurement and ranking tests were conducted. The results are presented in Table 1.

### Referential Example 1

A recording medium was prepared in a similar manner as in Example 2 except that the cationic resin was not added, and measurement and ranking tests were conducted. The results are presented in Table 1.

### Comparative Example 1

A recording medium was prepared in a similar manner as in Example 3 except that the re-drying at 40° C. for 90 minutes was not conducted, and measurement and ranking tests were conducted. The results are presented in Table 1.

### Comparative Example 2

A recording medium was prepared in a similar manner as in Example 4 except that the drying after the coating was conducted at 110° C. for 15 minutes, and measurement and ranking tests were conducted. The results are presented in Table 1.

TABLE 1
Results of Measurements and Ranking

| | Concentration of | Concentration of | |
|---|---|---|---|
| | acetic acid by | acetic acid by | Dye |
| | Measurement 1 | Measurement 2 | migration inhibiting |
| | (ppm/m² · L) | (ppm/m² · L) | effect |
| Example 1 | 0.29 | 0.97 | A |
| Example 2 | 0.15 | 1.17 | A |
| Example 3 | 0.54 | 1.56 | A |
| Example 4 | 0.69 | 1.95 | A |
| Ref. Ex. 1 | 0.39 | 1.36 | C |
| Comp. Ex. 1 | 1.18 | 2.73 | B |
| Comp. Ex. 2 | 1.71 | 3.90 | C |

As evident from Table 1, the recording media according to the present invention was suppressed in the lower fatty acid given off form the ink-receiving layers or from the ink-receiving layers shortly after the printing, and therefore, are reduced in the irritant odor (or unpleasant odor) of the lower fatty acid. Owing to the inclusion of the cationic resin in the ink-receiving layers, the recording media according to the present invention in which the concentrations of the residual lower fatty acid were controlled low were able to effectively prevent dye migration under the environment of high temperature and high humidity. In particular, even those added with small amounts of the cationic resin were able to obtain good moisture resistance. Further, the recording media according to the present invention were also excellent in image gloss and ink absorption property.

<<Third Aspect of the Present Invention>>

Ranking and measurements of various physical properties of each recording medium according to the third aspect of the present invention were conducted as will be described hereinafter.

<Measurement 3: Surface Roughness>

Using “Form Talysurf S5” (trade name, manufactured by Taylor Hobson Ltd.), the arithmetic mean roughness Ra (μm) of the surface of the ink-receiving layer on each recording medium was measured by setting the cut-off value and measurement length at 0.25 mm and 1.25 mm, respectively, as specified in JIS-B-0601.

<Measurement 4: Gloss>

Using a glossmeter (“VG-2000”, trade name; manufactured by Nippon Denshoku Industries Co., Ltd.), the 75-deg. specular gloss, as specified in JIS-Z-8741, of the surface of the ink-receiving layer on each ink-jet recording sheet was measured.

<Ranking 2: Migration Preventing Effect>

Ranked in a similar manner as in the first and second aspects of the present invention.

<Measurement 5: Fading and Discoloration Inhibiting Effects>

On each recording medium, solid printing (ink dot area: 100%) was performed with single-color inks of yellow (Y), magenta (M), cyan (C) and black (Bk) by using an ink-jet recording machine (“BJF900”, trade name; manufactured by Canon Inc.). By ozone exposure testing equipment (manufactured by SUGA TEST INSTRUMENTS CO., LTD.), the recorded medium was exposed to ozone of 3 ppm concentration for 2 hours at 40° C. and 55% RH. Using an optical densitometer (“RD-918”, trade name; manufactured by GretagMacbeth AG), the optical density (OG) of the printed area was next measured before and after the exposure to ozone, and the percent remainder of density (percent remainder of OD) was determined.

<Preparation of Alumina Hydrate Dispersion>

To deionized water (100 parts), the alumina hydrate powder (19 parts) obtained in the first and second aspects of the present invention and a 6% aqueous solution of acetic acid (11.5 parts, 3% based on the alumina hydrate) were added. The resulting mixture was agitated at 2,000 rpm for 5 minutes in a homomixer (manufactured by Tokushu Kika Kogyo Co., Ltd.) to obtain an alumina hydrate dispersion C (average particle size of the alumina hydrate: 175.4 nm).

### Example 5

Mixed in the alumina hydrate dispersion C (100 parts) were “SumirezResin 1001” (0.063 part, 0.1% based on the alumina hydrate; trade name, 30% aqueous solution; product of Sumitomo Chemical Co., Ltd.) as an acrylamide-diallylamine hydrochloride copolymer and a 3% aqueous solution of boric acid (3.17 parts, 0.5% based on the alumina hydrate) to form a dispersion C′. To the dispersion, a solution (19 parts) of polyvinyl alcohol (5 parts; “PVA-235”, trade name; product of Kuraray Co., Ltd.) in deionized water (45 parts) was added to prepare a coating formulation.

Using resin-coated paper of 234 g/m² in basis weight (product of Oji Paper Co., Ltd.) as a base material, the above-prepared coating formulation was applied to the base material by die-coating to give a dry coat weight of 30 g/m². The thus-coated base material was then dried with hot air at 110° C. for 15 minutes to form an ink-receiving layer. Using the thus-obtained recording medium, the above-described tests for the measurements 3 to 5 and the ranking 2 were conducted. The results of the measurements 3 and 4 are presented in Table 1, and the results of the measurement 5 and ranking 2 are presented in Table 3.

### Example 6

A recording medium was prepared in a similar manner as in Example 5 except that the amount of the acrylamide-diallylamine hydrochloride copolymer was changed to 0.317 part (0.5% based on the alumina hydrate) and the amount of the 3% aqueous solution of boric acid was changed to 12.7 parts (2% based on the alumina hydrate), and measurement and ranking tests were conducted. The results are presented in Table 2 and Table 3.

### Example 7

A recording medium was prepared in a similar manner as in Example 6 except that the amount of acrylamide-diallylamine hydrochloride copolymer was changed to 0.63 part (1.0% based on the alumina hydrate), and ranking and measurement tests were conducted. The results are presented in Table 2 and Table 3.

### Example 8

A recording medium was prepared in a similar manner as in Example 5 except that the amount of the acrylamide-diallylamine hydrochloride copolymer was changed to 1.90 parts (3.0% based on the alumina hydrate) and the amount of the 3% aqueous solution of boric acid was changed to 9.50 parts (1.5% based on the alumina hydrate), and measurement and ranking tests were conducted. The results are presented in Table 2 and Table 3.

### Comparative Example 3

A recording medium was prepared in a similar manner as in Example 7 except that the acrylamide-diallylamine hydrochloride copolymer was not added, and ranking and measurement tests were conducted. The results are presented in Table 2 and Table 3.

### Comparative Example 4

A recording medium was prepared in a similar manner as in Example 8 except that the amount of the 3% aqueous solution of boric acid was changed to 19.0 parts (3% based on the alumina hydrate), and measurement and ranking tests were conducted. The results are presented in Table 2 and Table 3.

### Comparative Example 5

A recording medium was prepared in a similar manner as in Example 7 except that “PAA-HCl-3L” (trade name for polyallylamine hydrochloride, 50% aqueous solution; product of Nitto Boseki Co., Ltd.) was added in a proportion of 0.38 part (1.0% based on the alumina hydrate) in place of the acrylamide-diallylamine hydrochloride copolymer, and measurement and ranking tests were conducted. The results are presented in Table 2 and Table 3.

### Comparative Example 6

A coating formulation was prepared in a similar manner as in Example 7 except that “PAS-M-1” (trade name for N-methyl-diallylamine hydrochloride polymer, 60% aqueous solution; product of Nitto Boseki Co., Ltd.) was added in a proportion of 0.317 part (1.0% based on the alumina hydrate) in place of the acrylamide-diallylamine hydrochloride copolymer. As the coating formulation gelled in about 10 minutes after the preparation, it was impossible to prepare any recording medium.

TABLE 2

| | Surface roughness | |
|---|---|---|
| | Ra (μm) | 75-deg. gloss |
| Example 5 | 0.036 | 68.6 |
| Example 6 | 0.036 | 66.9 |
| Example 7 | 0.045 | 64.8 |
| Example 8 | 0.079 | 61.5 |
| Comp. Ex. 3 | 0.031 | 69.3 |
| Comp. Ex. 4 | 0.129 | 50.3 |
| Comp. Ex. 5 | 0.121 | 56.2 |

TABLE 3

| | | Fading and discoloration | | | |
|---|---|---|---|---|---|
| | Dye migration | inhibiting effect | | | |
| | inhibiting | Percent remainder of OD | | | |
| | effect | Y | M | C | Bk |
| Example 5 | A | 99.3 | 82.1 | 57.9 | 49.7 |
| Example 6 | A | 99.2 | 85.4 | 62.5 | 50.3 |
| Example 7 | A | 99.4 | 82.9 | 59.1 | 50.2 |
| Example 8 | A | 98.5 | 81.6 | 57.3 | 48.5 |
| Comp. Ex. 3 | C | 99.6 | 82.2 | 63.2 | 50.6 |
| Comp. Ex. 4 | A | 98.6 | 81.5 | 55.9 | 48.2 |
| Comp. Ex. 5 | B | 94.3 | 75.1 | 45.1 | 38.9 |

As is evident from Table 2, each recording medium prepared with the constitution of the present invention contained the cationic resin but, as the coating formulation was less susceptible to gelation, the smoothness of the surface of the ink-receiving layer after the coating successfully remained at substantially the same level as those of recording media which did not contain the cationic resin. As is also understood from Table 3, the recording of an image on each recording medium according to the present invention effectively prevented post-printing migration of the dyes under an environment of high temperature and high humidity and further, successfully inhibited discoloration and fading by nitrogen oxides, sulfur oxide, ozone and the like in the air, which affect the fastness of images in rooms.

### INDUSTRIAL APPLICABILITY

According to the first or second aspect of the present invention, the concentration of a lower fatty acid which remains in an ink-receiving layer composed of an alumina hydrate is controlled to a specific range. This makes it possible to provide a recording medium inhibited in dye migration after printing and also reduced in irritant odor (or offensive odor) of a lower fatty acid from the ink-receiving layer or from the ink-receiving layer shortly after printing.

According to the third aspect of the present invention, an alumina hydrate, a water-soluble resin and/or water-dispersible resin, a cationic resin, and a boron compound are contained in specific proportions in an ink-receiving layer, and the roughness of a surface of the ink-receiving layer is controlled to a specific range. This makes it possible to provide a recording medium having a high gloss, permitting printing of excellent quality, and inhibited in dye migration after printing and also in image fading and discoloration by storage over extended time.

1. A recording medium composed of a base material and an ink-receiving layer comprising a lower fatty acid, an alumina hydrate and an acrylamide-diallylamine hydrochloride copolymer and arranged on at least one side of said base material, characterized in that, when heated at 60° C. for 1 hour, said recording medium gives off a lower fatty acid at a concentration in a range of from 0.1 to 1.0 ppm/m²·L.

2. A recording medium composed of a base material and an ink-receiving layer formed of a lower fatty acid, an alumina hydrate and an acrylamide-diallylamine hydrochloride copolymer and arranged on at least one side of said base material, characterized in that, when heated at 60° C. for 1 hour, said recording medium gives off a lower fatty acid at a concentration in a range of from 0.1 to 1.0 ppm/m²·L and, when left over at 23° C. for 10 minutes subsequent to formation of an image on the ink-receiving layer of said recording medium, said recording medium gives off a lower fatty acid at a concentration not higher than 2.5 ppm/m²·L.

3. (canceled)

4. A recording medium sheet composed of a base material and an ink-receiving layer arranged on a surface of said base material, characterized in that said ink-receiving layer comprises:
an alumina hydrate,
at least one binder resin selected from a water-soluble resin and a water-dispersible resin,
a cationic resin, and
a boron compound,
wherein said cationic resin is an acrylamide-diallylamine hydrochloride copolymer; said alumina hydrate, said at least one binder resin, said cationic resin and said boron compound satisfy the following equations (1) and (2):
A>20×C Equation (1),
and
B>2×(C+D) Equation (2)
wherein
A: weight proportion of said alumina hydrate,
B: weight proportion of said at least one binder resin,
C: weight proportion of said cationic resin, and
D: weight proportion of said boron compound; and
said ink-receiving layer has at a surface thereof an arithmetic mean roughness Ra not greater than 0.1 μm when measured by setting the cut-off value and measurement length at 0.25 mm and 1.25 mm as specified in JIS-B-0601.

5. (canceled)

6. A recording medium according to claim 4, wherein said water-soluble resin is polyvinyl alcohol.

7. A recording medium according to claim 4, wherein said boron compound is a boric acid or a borate salt.

8. A recording medium according to claim 1, wherein said base material is a film or polyolefin-resin-coated paper.
